(19) United States
(12) Patent Application Publication
(10) Pub. No.: US 2008/0087016 A1
(43) Pub. Date: Apr. 17, 2008

(54) Piston to seal configuration for a fixed seal master cylinder

(75) Inventors: Robert H. Shepherd, Beavercreek, OH (US); James W. Zehnder, Tipp City, OH (US); Michael W. Hurtt, Waynesville, OH (US)

Correspondence Address: DELPHI TECHNOLOGIES, INC., M/C 480-410-202, PO BOX 5052, TROY, MI, 48007, US

(73) Assignees: Robert H. Shepherd; James Zehnder; Michael W. Hurtt

(21) Appl. No.: 11/706,004

(22) Filed: Feb. 14, 2007

Related U.S. Application Data
(60) Provisional application No. 60/851,425, filed on Oct. 13, 2006.

(51) Int. Cl. B60T 11/20

(52) U.S. Cl. 60/562

(57) ABSTRACT

An improved piston to seal configuration for a master cylinder including a master cylinder housing defining a bore, the bore defining an elongated axis, a seal groove defined by the master cylinder housing and disposed about the bore, a seal positioned within the seal groove and a piston closely and slideably received within the bore, wherein the piston includes a distal end and a chamfer formed on the distal end, the chamfer being adapted to engage the seal, with the caveat that the piston is free of bypass holes.

The present application claims priority from U.S. Provisional Ser. No. 60/851,425, filed on Oct. 13, 2006, the entire contents of which are incorporated herein by reference.

### BACKGROUND

The present application is directed to fixed seal master cylinders and, more particularly, to improved piston to seal configurations for fixed seal master cylinders.

Fixed seal master cylinders have been developed for use in various vehicle braking systems to transfer hydraulic force to the braking devices (e.g., disk brakes) of the vehicle. However, there remains a need for more compact fixed seal master cylinders capable of being manufactured at a reduced cost.

### SUMMARY

In one aspect, the improved piston to seal configuration for a master cylinder may include a master cylinder including a master cylinder housing defining a bore, the bore defining an elongated axis, a seal groove defined by the master cylinder housing and disposed about the bore, a seal positioned within the seal groove and a piston closely and slideably received within the bore, wherein the piston includes a distal end and a chamfer formed on the distal end, the chamfer being adapted to engage the seal, with the caveat that the piston is free of bypass holes.

In another aspect, the improved piston to seal configuration for a master cylinder may include a master cylinder housing defining a generally cylindrical bore, the bore defining an elongated axis, a seal groove defined by the master cylinder housing and disposed generally circumferentially about the bore, a seal positioned within the seal groove, wherein the seal includes an inner diameter lip extending radially inwardly into the bore, and a piston slideably received within the bore to define a piston fluid chamber and a forward fluid chamber, wherein the piston is moveable relative to the seal and includes a chamfered distal end adapted to engage the inner diameter lip of the seal to form a seal between the piston fluid chamber and the forward fluid chamber, with the caveat that the piston is free of bypass holes.

Other aspects of the disclosed improved piston to seal configuration for a master cylinder will become apparent from the following description, the accompanying drawings and the appended claims.

### BRIEF DESCRIPTION OF THE DRAWINGS

FIG. 1 is a cross-sectional view of a prior art fixed seal master cylinder;

FIG. 2 is a cross-sectional view of a portion of the primary circuit of the master cylinder of FIG. 1; and

FIG. 3 is a cross-sectional view of a portion of a primary circuit according to an aspect of the disclosed improved piston to seal configuration.

### DETAILED DESCRIPTION

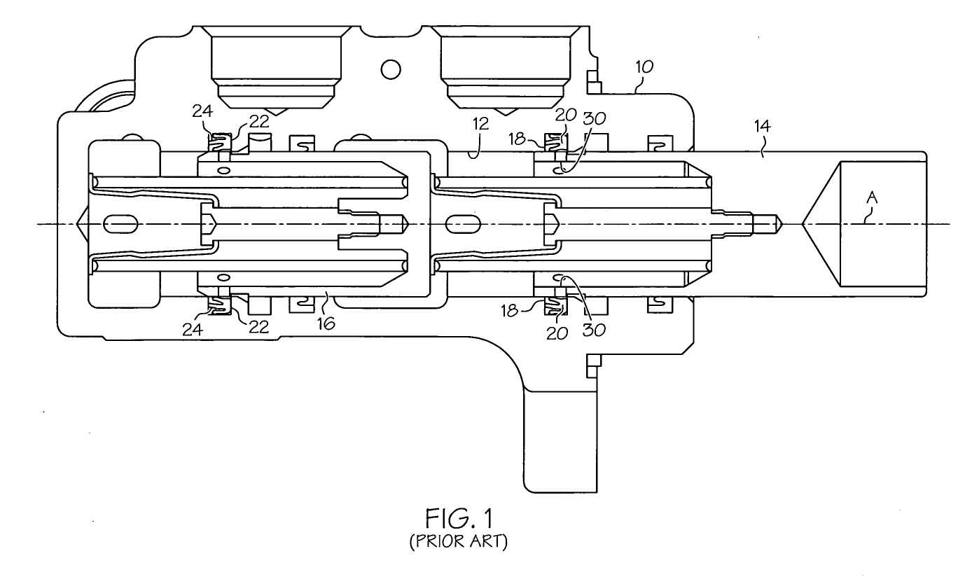

Referring to FIG. 1, a prior art fixed seal master cylinder, also known as a stationary seal master cylinder, generally includes a cylinder housing 10 defining an elongated bore 12 therein, the elongated bore having an elongated axis A. A primary piston 14 and, optionally, a secondary piston 16 may be closely and slideably received within the bore 12. Additionally, the bore 12 may define a primary seal groove 18 having a primary seal 20 positioned therein and, optionally, a secondary seal groove 22 having a secondary seal 24 positioned therein.

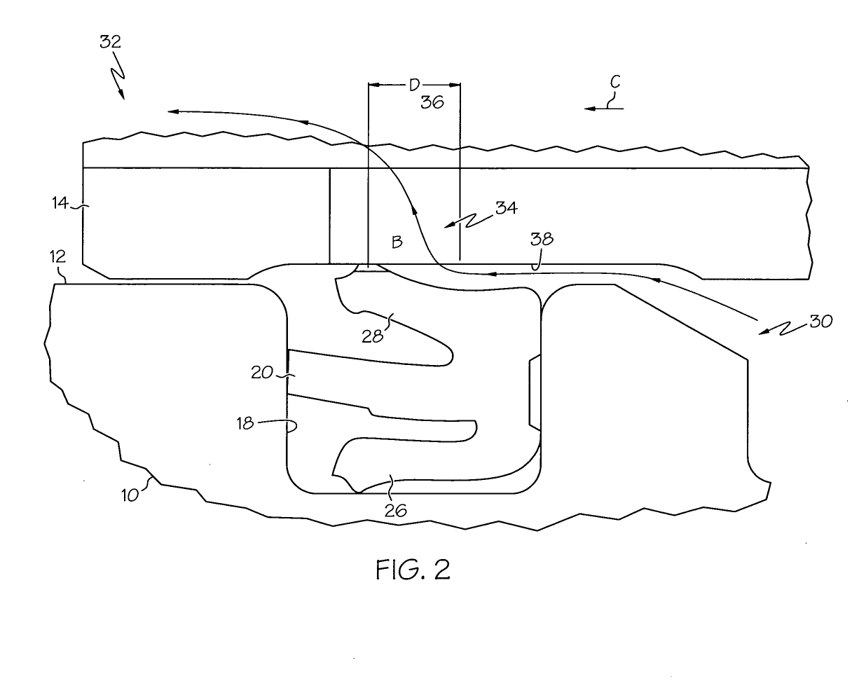

Referring to FIG. 2, the seal 20 may include an outer diameter lip 26 that contacts the seal groove 18 and an inner diameter lip 28 that is biased into engagement with the piston 14 to form a fluid tight seal between the piston 14 and the bore 12. The contact between the seal 20 and the piston 14 may define a piston fluid chamber 30 proximal to the seal 20 and a forward fluid chamber 32 distal to the seal 20.

The piston 14 may include one or more bypass holes 34 positioned near the distal end 36 of the piston 14 to create a fluid flow path, shown by arrow B in FIG. 2, from the piston fluid chamber 30 to the forward fluid chamber 32. As the piston 14 is advanced in the distal direction (arrow C in FIG. 2), the fluid flow through the bypass holes 34 is restricted by the seal 20 until the piston 14 has traveled the full travel to close (“TTC”) distance D, at which point the seal 20 fully engages the sealing surface 38 of the piston 14 to substantially prevent fluid flow between the piston fluid chamber 30 and the forward fluid chamber 32. The pressure in the forward fluid chamber 32 will begin to rapidly increase after the piston has traveled the TTC distance D.

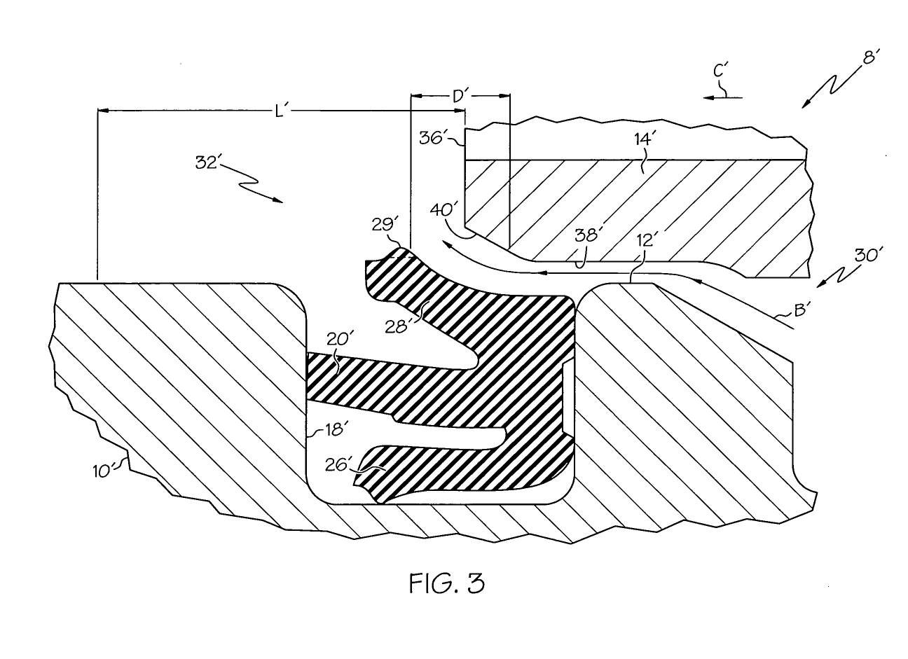

Referring to FIG. 3, one aspect of the disclosed improved piston to seal configuration of a master cylinder, generally designated 8′, may include a cylinder housing 10′ defining an elongated bore 12′ therein, a piston 14′ closely and slideably received within the bore 12′, and a seal groove 18′ circumferentially disposed about the bore 12′, the seal groove 18′ having a seal 20′ positioned therein to engage the piston 14′. The piston 14′ may define a piston fluid chamber 30′ proximal to the piston 14′ and a forward fluid chamber 32′ distal to the piston 14′. The piston fluid chamber 30′ and the forward fluid chamber 32′ may be filled with a hydraulic fluid.

In one aspect, the seal 20′ may include an outer diameter lip 26′ that contacts the seal groove 18′ and an inner diameter lip 28′ that is biased into engagement with the piston 14′ to form a fluid tight seal between the piston 14′ and the bore 12′. However, those skilled in the art will appreciate that various seals and seal configurations may be used without departing from the scope of the present disclosure. Furthermore, those skilled in the art will appreciate that the seal 20′ may be formed from an elastic material, such as an elastic, polymeric material, or any other suitable material.

The piston 14′ may include a chamfer 40′ and may be free of bypass holes 34 (FIG. 2). Furthermore, the piston 14′ may be shorter than prior art pistons (e.g., piston 14 of FIGS. 1 and 2) by a length L′, wherein the length L′ may correspond to the distal portion 36, including the bypass holes 34, of a prior art piston 14 shown in FIG. 2.

Thus, a fluid flow path, shown by arrow B′ in FIG. 3, may be established from the piston fluid chamber 30′ to the forward fluid chamber 32′ between the piston 14′ and the bore 12′ and, ultimately, between the inner diameter lip 28′ of the seal 20′ and the chamfer 40′ of the piston 14′. However, as the piston 14′ is advanced in the distal direction (arrow C′ in FIG. 3), the spacing between the chamfer 40′ and the inner diameter lip 28′ may be reduced, thereby restricting fluid flow therethrough.

Once the piston 14′ has traveled the full travel to close (TTC) distance D′ such that the tip 29′ of the inner diameter lip 28′ is initially engaged with the chamfer 40′, a seal may be formed between the piston 14′ and the bore 12′ to substantially prevent fluid flow between the piston fluid chamber 30′ and the forward fluid chamber 32′. As the piston 14′ continues to travel beyond the TTC distance D′, the inner diameter lip 28′ may cam over the surface of the piston 14′ from the chamfer 40′ of the piston 14′ to the sealing surface 38′ of the piston 14′, thereby maintaining a seal between the piston 14′ and the bore 12′.

At this point, those skilled in the art will appreciate that the configuration 8′ discussed above may be applied to primary and/or secondary circuits of master cylinders.

Although various aspects of the disclosed improved piston to seal configuration have been shown and described, modifications may occur to those skilled in the art upon reading the specification. The present disclosure contemplates and includes such modifications and is limited only by the scope of the claims.

What is claimed is:

1. A fixed seal master cylinder comprising:
a master cylinder housing defining a bore, said bore defining an elongated axis;
a seal groove defined by said master cylinder housing and disposed about said bore;
a seal positioned within said seal groove; and
a piston closely and slideably received within said bore, wherein said piston includes a distal end and a chamfer formed on said distal end, said chamfer being adapted to engage said seal, with the caveat that said piston is free of bypass holes.

2. The master cylinder of claim 1 wherein said seal includes an inner diameter lip biased radially inwardly with respect to said axis of said bore.

3. The master cylinder of claim 2 wherein said inner diameter lip is adapted to engage said chamfer on said piston.

4. The master cylinder of claim 1 wherein said seal includes an outer diameter lip engaged with said seal groove.

5. The master cylinder of claim 2 wherein said piston further includes a sealing surface and said inner diameter lip of said seal is adapted to engage said sealing surface when said piston is advanced in a distal direction.

6. The master cylinder of claim 1 wherein said piston defines a piston fluid chamber and a forward fluid chamber within said bore, wherein said piston fluid chamber is in fluid communication with said forward fluid chamber by way of a fluid flow path.

7. The master cylinder of claim 6 wherein said inner diameter lip of said seal is adapted to engage said chamfer on said distal end of said piston to obstruct said fluid flow path.

8. The master cylinder of claim 6 wherein said inner diameter lip of said seal is adapted to form a seal between said piston fluid chamber and said forward fluid chamber.

9. The master cylinder of claim 6 wherein said piston fluid chamber and said forward fluid chamber are generally filled with a hydraulic fluid.

10. The master cylinder of claim 1 wherein said seal is formed from an elastic material.

11. The master cylinder of claim 1 wherein said bore is generally cylindrical in shape and said seal groove is generally circumferentially disposed about said bore.

12. The master cylinder of claim 1 wherein said piston is associated with a primary circuit of said master cylinder.

13. The master cylinder of claim 1 further comprising a second piston closely and slideably received within said bore, wherein said second piston is associated with a secondary circuit of said master cylinder.

14. A fixed seal master cylinder comprising:
a master cylinder housing defining a generally cylindrical bore, said bore defining an elongated axis;
a seal groove defined by said master cylinder housing and disposed generally circumferentially about said bore;
a seal positioned within said seal groove, wherein said seal includes an inner diameter lip extending radially inwardly into said bore; and
a piston slideably received within said bore to define a piston fluid chamber and a forward fluid chamber, wherein said piston is moveable relative to said seal and includes a chamfered distal end adapted to engage said inner diameter lip of said seal to form a seal between said piston fluid chamber and said forward fluid chamber, with the caveat that said piston is free of bypass holes.

15. The master cylinder of claim 14 wherein said seal further includes an outer diameter lip engaged with said seal groove.

16. The master cylinder of claim 14 wherein said piston further includes a sealing surface and said inner diameter lip of said seal is adapted to engage said sealing surface when said piston is advanced in a distal direction.

17. The master cylinder of claim 14 wherein said piston fluid chamber and said forward fluid chamber are generally filled with a hydraulic fluid.

18. The master cylinder of claim 14 wherein said seal is formed from an elastic material.

19. The master cylinder of claim 14 wherein said piston is associated with a primary circuit of said master cylinder.

20. The master cylinder of claim 14 further comprising a second piston slideably received within said bore, wherein said second piston is associated with a secondary circuit of said master cylinder.
